(19) United States
(12) Patent Application Publication
(10) Pub. No.: US 2026/0126825 A1
(43) Pub. Date: May 7, 2026

(54) CONTROL DEVICE WITH PASSIVE FORCE FEEDBACK

(71) Applicant: Safran Electronics & Defense, Paris (FR)

(72) Inventors: Emilien MACCHI, MOISSY-CRAMAYEL (FR); Yannick Ghislain Sébastien Xavier ATTRAZIC, MOISSY-CRAMAYEL (FR); Nicolas RAUCH, MOISSY-CRAMAYEL (FR); Julie Denise QUEROIS, MOISSY-CRAMAYEL (FR); Benoït CRAPART, MOISSY-CRAMAYEL (FR)

(73) Assignee: Safran Electronics & Defense, Paris (FR)

(21) Appl. No.: 19/114,549

(22) PCT Filed: Sep. 28, 2023
(86) PCT No.: PCT/FR2023/051493

§ 371 Date: Mar. 24, 2025

(30) Foreign Application Priority Data
Sep. 30, 2022 (FR) FR2210035

(51) Int. Cl. G05G 9/047; B64C 13/04; G05G 5/05

(52) U.S. Cl. CPC G05G 9/047; G05G 5/05; B64C 13/0421; G05G 2009/04766

(57) ABSTRACT

A control device includes a mechanical seal which guides a rotation of a control lever relative to a frame about two pivot connections of orthogonal axes. The mechanical seal includes, for one or both of the pivot connections, a device that returns a movable part into a neutral position relative to a stationary part. The return device includes one or more elastic members including two branches each extending orthogonally to an axis of the pivot connection from a finger of one of the movable and stationary parts as far as a free end. Each elastic member prevents the free ends from moving towards one another. The elastic member is inserted, in a transverse direction orthogonal to a bisector of an angle between the two branches, between a stationary pin which is secured to the stationary part and a movable pin which is secured to the movable part.

### FIELD OF THE INVENTION

The present invention relates to a control device, particularly intended for piloting a vehicle comprising at least one aerodynamic or hydrodynamic control surface, such as an aircraft or a vessel.

More particularly, the invention relates to a control device used by the pilot in the cockpit of an aircraft, in particular a “side stick” comprising force feedback integrated to assist the pilot.

### TECHNOLOGICAL BACKGROUND

Numerous control devices are known which serve for the operation of machines, such as vehicles or robots, by human pilots maneuvering at least one control member such as a joystick, a lever, a rudder, a pedal, etc.

These known control devices comprise in particular control devices of the “joystick” type including a control lever mounted in rotation relative to a frame about a first axis called roll and a second axis called pitch, these two axes being orthogonal to one another. Depending on the position of the control member about these two axes, the joystick transmits movement commands to a machine. Such joysticks commonly equip aircraft, but also other vehicles, particularly vehicles comprising at least one aerodynamic or hydrodynamic control surface. They also serve for controlling remote robots in the context of teleoperation.

Conventionally, a system of cables provides a connection between the joystick and the control surfaces so that the pilot, by maneuvering the lever, directly transmits his forces to the control surfaces. This system of cables is still used in “light” airplanes. In heavier airplanes, hydraulic devices allow assisting the pilot.

In the more recent aircraft models, the control of the movements of the aircraft is generally electronic. The control device integrated in the cockpit is most often constituted by a particular type of joystick: the “side stick.” In this type of joystick, the position of the control lever about the two axes of roll and pitch is measured by sensors and translated into movement commands. These movement commands are then sent to actuators which control the movement of movable parts of the aircraft depending on said commands. The side sticks also find an application in other conventional domains of application of the joystick.

One disadvantage of the side stick is that, as the lever is not directly linked mechanically to the movable parts of the aircraft, there is no direct mechanical feedback to the lever. Hence the pilot is deprived of control sensations. For guiding his control, the pilot must then integrally rely on the signaling systems of the cockpit. However, these can be insufficient for triggering a sufficiently rapid reaction of the pilot during flight.

In order for a variable resistance to oppose the movement of the side stick actuated by the pilot, it is known to provide the latter with a force feedback system, also called “haptic feedback,” simulating a counter-reaction force of the control surfaces to a “conventional” joystick. It is generally sought that the force law of these systems, i.e. the intensity of the counter-force produced as a function of the angle of inclination of the lever, be:
asymmetrical for the roll axis, i.e. the intensity slope of the counter-force must vary depending on whether the angle of inclination of the lever is positive or negative, this in order to compensate the difference of strength of the pilot between pronation and supination, and
variable for the pitch axis, i.e. the intensity slope of the counter-force must vary when the lever separates by more than a certain angle from the neutral position.

Two major types of force feedback systems are distinguished: force feedbacks called “passive,” like those described in document FR 2 988 689 A1, in which the counter-reaction force is produced by passive elements such as springs, and so-called “active” force feedbacks, like that described in document EP 3 011 815, in which the counter-reaction force is produced by active elements such as actuators.

These known force feedback systems, however, do not give complete satisfaction.

Passive force feedbacks, first of all, have the disadvantage of generally simulating very poorly the counter-reaction force of the control surfaces. The force law is in fact mostly very simplistic. Very few passive force feedbacks are known that are able to produce an asymmetrical or variable force law, and those that can are generally bulky and complex to implement, often unreliable, and most often necessitate a long and laborious adjustment.

As for active force feedback systems, they are generally costly. In addition, they are vulnerable to electrical failure.

### Disclosure of the Invention

One object of the invention is to propose a control device of the joystick type equipped with a passive force feedback system able to produce a complex force law. Other objects of the invention are that this force feedback system be simple, inexpensive, easy to implement, reliable and easily configurable.

To this end, the invention has as its object a control device including a frame, a control lever and a mechanical seal guiding the control lever in rotation relative to the frame about two pivot connection with orthogonal axes, the mechanical seal comprising, for each of said pivot connections, a part that is stationary relative to the axis of the pivot connection, and part that is jointly movable with the control lever around the axis of the pivot connection relative to the stationary part, the mechanical seal also comprising, for at least one of the pivot connections, a device for returning the movable part into a predetermined position, called the neutral position, relative to the stationary part, in which said return device comprises at least one elastic member including a first branch extending in a first direction orthogonal to the axis of the pivot connection from a finger integral with one of the movable and stationary parts until a first free end, and a second branch extending in a second direction orthogonal to the axis of the pivot connection from said finger until a second free end, the or each elastic member being able to oppose a convergence of the first free end with the second free end, the elastic member being inserted, in a transverse direction orthogonal to the bisector of the angle between the first direction and the second direction, between a stationary pin integral with the stationary part and a movable pin integral with the movable part.

According to the particular embodiments of the invention, the control device also has one or more of the following features, taken in isolation or in any combination:
the elastic member is inserted, in the transverse direction, between a first stationary pin integral with the stationary part and a second stationary pin integral with the stationary part;
the first branch is supported against the first stationary pin and the second branch is supported against the second stationary pin when the movable part is in its neutral position, the elastic member being preloaded between said first stationary pin and said second stationary pin;
the elastic member is inserted, in the transverse direction between a first movable pin integral with the movable part and a second movable pin integral with the movable part;
when the movable part is in its neutral position, a first distance between the first movable pin and the first branch is substantially equal to a second distance between the second movable pin and the second branch;
a first distance between the first movable pin and the finger is strictly less than or equal to a second distance between the second movable pin and the finger;
the elastic member is inserted, in the transverse direction, between, on the one hand, a plurality of movable pins integral with the movable part and, on the other hand, at least one stationary pin integral with the stationary part, the movable parts being aligned along a straight line intersecting the axis of the pivot connection and comprising a proximal movable pin, near the finger, and a distal movable pin, distant from the finger, the first branch comprising a rectilinear portion, able to be supported against said movable pins and extending in a direction not intersecting with the axis of the pivot connection when the movable part is in its neutral position, said portion being closer to the proximal movable pin than to the distal movable pin when the movable part is in its neutral position, the finger being integral with the stationary part;
the return device comprises a plurality of elastic members;
the elastic members comprise a primary elastic member inserted, in the transverse direction, between a first primary movable pin integral with the movable part and a second primary movable pin integral with the movable part, and a secondary elastic member inserted in the transverse direction between a first secondary movable pin integral with the movable part and a second secondary movable pin integral with the movable part, a first primary distance between the first primary movable pin and the first branch of the primary elastic member and/or a second primary distance between the second primary movable pin and the second branch of the primary elastic member being different from a first secondary distance between the first secondary movable pin and the first branch of the secondary elastic member and from a second secondary distance between the second secondary movable pin and the second branch of the secondary elastic member;
the elastic members have different stiffnesses;
the or each movable in has a support surface against the first or the second branch of the elastic member, said support surface being constituted by a cam surface;
the finger is integral with the movable part;
the finger is integral with the stationary part;
the finger is at a distance from the axis of the pivot connection;
the or each elastic member consists of a torsion spring wound around the finger;
the mechanical seal comprises a cradle, mounted movable in rotation relative to the frame about a first pivot connection around a first axis, and a plate, integral with the control lever, mounted movable in rotation relative to the cradle about a second pivot connection around a second axis, orthogonal to the first axis;
the first and second axes intersect;
the movable part consists of the cradle, the stationary part consists of the frame; and
the movable part consists of the plate; the stationary part consists of the cradle.

### BRIEF DESCRIPTION OF THE FIGURES

Other features and advantages of the invention will appear upon reading the description that follows, given solely by way of an example and provided with reference to the appended drawings, in which:

FIG. 1 is a schematic of an example of a control system of an aircraft,

FIG. 2 is a perspective view of a control device equipping the control system of FIG. 1 according to one exemplary embodiment of the invention,

FIG. 3 is a transverse section view of the control device of FIG. 2 in a first plane marked III-III in FIG. 2, in which is visible a first variant of a first return device,

FIGS. 4 and 5 are outline schematics explaining the operation of said first variant of the first return device,

FIG. 6 is a graphic illustrating a force law of the first variant of the first return device,

FIG. 7 is a longitudinal section view of the control device of FIG. 2 in a second plane marked VII-VII in FIG. 2, in which is visible a first variant of a second return device,

FIGS. 8 and 9 are outline schematics explaining the operation of said first variant of the second return device,

FIG. 10 is a graphic illustrating a force law of the first variant of the second return device,

FIG. 11 is a schematic of a second variant of the first return device,

FIGS. 12 and 13 are outline schematics explaining the operation of said second variant of the first return device,

FIG. 14 is a graphic illustrating a force law of the second variant of the first return device,

FIG. 15 is a schematic of a second variant of the second return device,

FIG. 16 is an outline schematic explaining the operation of said second variant of the second return device,

FIG. 17 is a graphic illustrating a force law of the second variant of the second return device,

FIG. 18 is a schematic of a third variant of the first return device, and

FIG. 19 is a graphic illustrating a force law of the third variant of the first return device.

### DETAILED DESCRIPTION OF AN EXEMPLARY EMBODIMENT

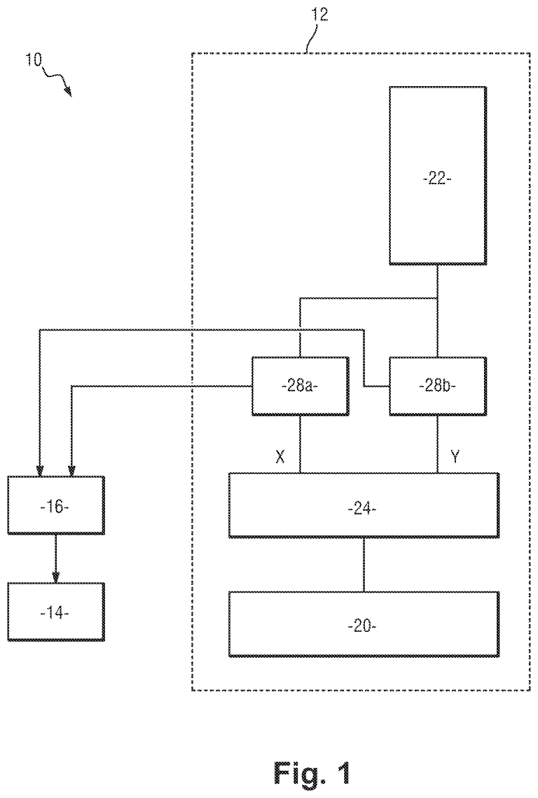

The control system 10 shown in FIG. 1 is configured to allow the control of a vehicle, in particular an aircraft, by a human pilot. To this end, the control system 10 comprises a control device 12 able to be maneuvered by the pilot, at least one actuator 14, typically an electrical actuator, able to move a movable member (not shown), typically a control surface, of the vehicle, and a control unit 16 configured to control the or each actuator 14 depending on the actions of the pilot on the control device 12, the control unit 16 typically consisting of a flight control system (better known by the abbreviation FCS).

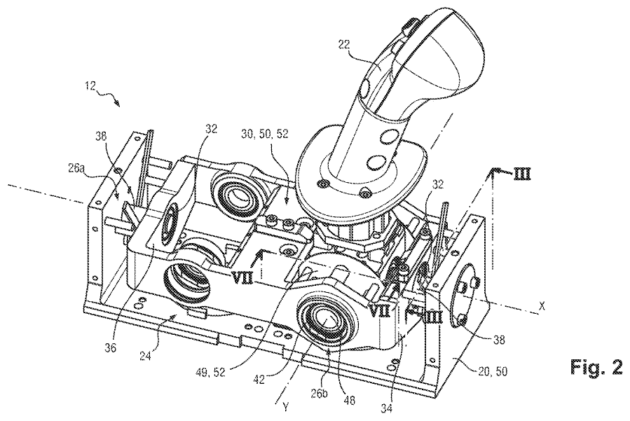

In particular, the control device 12 comprises a frame 20, typically integral with an aircraft floor (not shown), a control lever 22 graspable by a human pilot and a mechanical seal 24, the mechanical seal 24 guiding the control lever 22 in rotation relative to the frame 20 about a first pivot connection 26a (FIG. 2) with axis X, and about a second pivot connection 26b (FIG. 2) with axis Y, said axes X, Y being orthogonal and intersecting. The control device 12 also comprises a first position sensor 28a associated with the axis X and a second position sensor 28b associated with the axis Y, each being configured to communicate to the control unit 16 an electronic signal representing the position of the lever 22 relative to the axis X, Y with which it is associated. Optionally, the sensors 26, 28 are also configured to communicate electronic signals representing the speed of the lever 22 about the axes X, Y. The control unit 16 is configured to translate this position and, if applicable, speed information of the lever 22 relative to the axes X, Y into control signals of the or of each actuator 14.

The axis X is preferably a roll axis, i.e. the position of the lever 22 around this axis is interpreted by the control unit 16 to control the roll of the aircraft. The axis Y is preferably a pitch axis, i.e. the position of the lever 22 around this axis is interpreted by the control unit 16 for controlling the pitch of the aircraft. As a variant, the functions of the axes X and Y are interchanged, the axis X being a pitch axis and the axis Y a roll axis. Also as a variant, the position of the lever around the axes X and Y is interpreted in any other manner by the control unit 16. For example, the position of the lever 22 around the axis X can be interpreted by the control unit 16 for controlling a right/left orientation of the vehicle and the position of the lever around the axis Y can be interpreted by the control unit 16 for controlling forward and/or reverse movement of the vehicle.

The control device 12 is presented in more detail in FIG. 2, in the form of an aircraft control side stick. In this exemplary embodiment, the mechanical seal 24 comprises a cradle 30 kinematically inserted between the frame 20 and the lever 22, i.e. the kinematic chain connecting the frame 20 to the lever 22 comprises a first kinematic linkage between the frame 20 and the cradle 30 and a second kinematic linkage between the lever 22 and the cradle 30. Here the cradle 30 consists of a rectangular framework.

Here the first kinematic linkage consists of the first pivot connection 26a, i.e. the cradle 30 is mounted in rotation relative to the frame 20 around the axis X by means of the first pivot connection 26a. Here this first pivot connection 26a is embodied by two bearings 32 provided in the opposite longitudinal faces 34, 36 of the cradle 30 and in each of which is housed a shaft 38 integral with the frame 20.

Here the second kinematic linkage consists of the second pivot connection 26b, i.e. the lever 22 is mounted in rotation relative to the cradle 30 around the axis Y by means of the second pivot connection 26b. Here this second pivot connection 26b is embodied by two bearings 42 (of which only one is visible in FIG. 2) provided in opposite lateral faces 44, 46 of the cradle 30 and in each of which is housed a shaft 48 integral with a plate 49, itself integral with the lever 22. It will be noted that the axis Y is thus linked to the cradle 30, so that a pivoting of the cradle 30 around the axis X pivots the axis Y around the axis X.

The cradle 30 is suitable for pivoting around the axis X on either side of a position, called the neutral position of the cradle, in which the plane of the cradle 30, defined by the two axes X and Y, is substantially parallel to the base of the frame 20. The angular travel of the cradle 30 on each side of this neutral position is preferably approximately 60°.

The lever 22 is suitable for pivoting around the axis Y on either side of a position, called the neutral position of the lever, in which the axis of elongation of the lever 22 is substantially orthogonal to the plane of the cradle 30. The angular travel of the lever 22 on either side of this neutral position is preferably approximately 60°.

The mechanical seal 24 thus comprises, for each of the pivot connections 26a, 26b, a part 50 that is stationary relative to the X or Y axis of the pivot connection 26a, 26b when the control lever 22 is pivoted relative to the frame 20 around the axis X or Y of the pivot connection 26a, 26b, and a part 52 that is jointly movable with the control lever 22 around the axis X or Y of the pivot connection 26a, 26b relative to the stationary part 50. In the case of the first pivot connection 26a, the stationary part 50 consists of the frame 20, the movable part 52 consisting of the cradle 30. In the case of the second pivot connection 26b, the stationary part 50 consists of the cradle 30, the movable part 52 consisting of the plate 49.

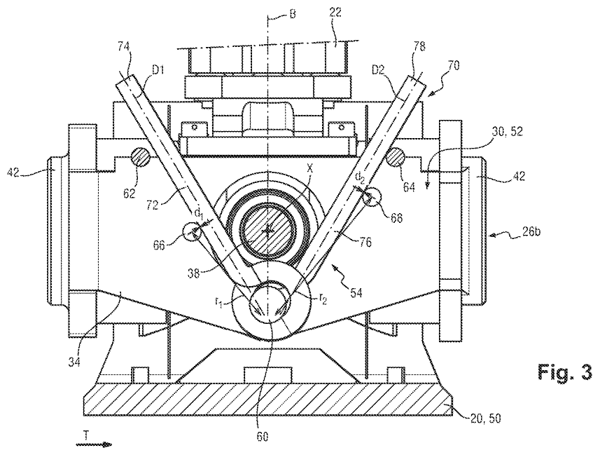

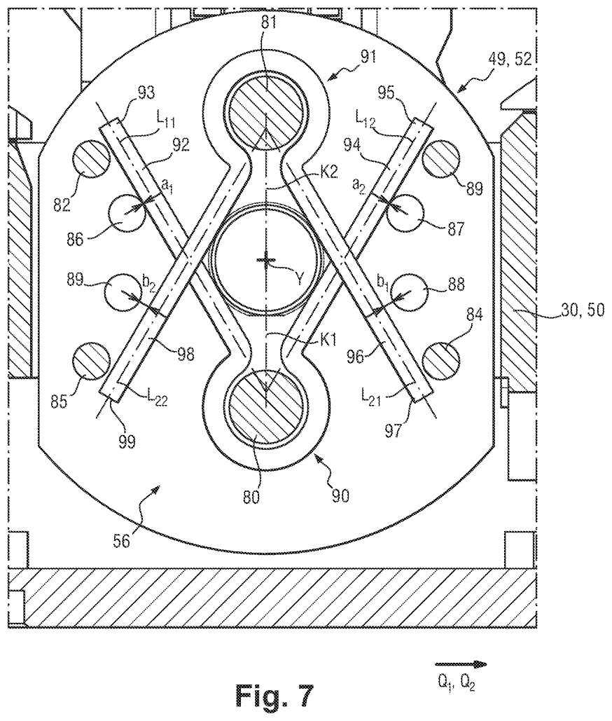

The mechanical seal 24 also comprises, for each of the pivot connections 26a, 26b, a device 54, 56 for returning the movable part 52 to its neutral position relative to the stationary part 50. Regarding the first pivot connection 26a, this return device consists of a first return device 54 (FIG. 3). Regarding the second pivot connection 26b, this return device consists of a second return device 56 (FIG. 7).

### First Variant of the First Return Device 54

A first variant of the return device 54 is shown in FIGS. 3 to 5.

With reference to FIG. 3, the first return device 54 comprises, according to this first variant, a finger 60 integral with the cradle 30, this finger 60 protruding from a face of the cradle 30, parallel to the axis X, toward the frame 50. Here the finger 60 is eccentric, i.e. it is at a distance from the axis X.

The first return device 54 also comprises two stationary pins 62, 64 each integral with the frame 50 and protruding from a face of the frame 50, parallel to the axis X, toward the cradle 30, and two movable pins 66, 68 each integral with the cradle 30 and protruding from a face of the cradle 30, parallel to the axis X, toward the frame 50.

Here, the stationary pins 62, 64 are substantially equidistant from the axis X. In addition, the stationary pins 62, 64 are substantially equidistant from the finger 60 when the cradle 30 is in its neutral position.

Moreover, the movable pins 66, 68 are at different distances from the axis X and at different distances from the finger 60 when the cradle 30 is in its neutral position. For example, the first movable pin 66 is, as shown, at a first distance r₁ from the finger 60 that is strictly less than a second distance r₂ between the second movable pin 68 and the finger 60. Each of said distances r₁, r₂ is measured between the center of the finger 60 and the center of the movable pin, respectively 66, 68, in a plane orthogonal to the axis X, when the cradle 30 is in its neutral position.

Optionally, at least a part of the pins 62, 64, 66, 68 comprises a body (not shown) and a roller (not shown) mounted in rotation relative to said body around an axis parallel to the axis X centered on said body.

In the example shown, the pins 62, 64, 66, 68 are on one side of the axis X, the finger 60 being on the other side. In other words, there exists a plane containing the axis X dividing the space into two halves, the pins 62, 64, 66, 68 being contained in the first of these halves and the finger 60 being contained in the second half. This arrangement allows good compactness of the return device 54.

The first return device 54 also comprises a V-shaped elastic member 70 including a first rectilinear branch 72 extending along a first direction D1 orthogonal to the axis X from the finger 60 until a first free end 74 and a second rectilinear branch 76 extending along a second direction D2 orthogonal to the axis X from the finger 60 until a second free end 78. These directions D1, D2 form an (unlabeled) angle. This angle is divided into two equal halves by a bisector B. Advantageously this bisector B, as shown, intersects the axis X when the cradle 30 is in its neutral position.

The elastic member 70 is able to oppose a convergence of the first and second free ends 74, 78.

The elastic member 70 consists for example, as shown, of a torsion spring wound around the finger 60. As a variant (not shown), the elastic member consists of a couple of leaf springs made integral with the finger 60 by at one of their ends, each leaf spring constituting one of the branches 72, 76 of the elastic member 70.

The elastic member 70 is inserted, in a transverse direction T orthogonal to the axis X and to the bisector B of the angle between the first and second directions D1, D2, between a first 62 of the stationary pins 62, 64 and a second 64 of said stationary pins 62, 64. In other words, the stationary pins 62, 64 flank the elastic member 70 in the transverse direction T.

In particular, the first branch 72 of the elastic member 70 is in contact with the first stationary pin 62 and the second branch 74 of the elastic member 70 is in contact with the second stationary pin 64 when the cradle 30 is in its neutral position. Preferably, each of these contacts is supported, i.e. the first branch 72 of the elastic member 70 is supported against the first stationary pin 62 and the second branch 74 of the elastic member 70 is supported against the second stationary pin 64 when the cradle 30 is in its neutral position. To this end, the elastic member 70 is preloaded between said stationary pins 62, 64. Thus the return device 64 exerts a significant counter-force beginning with the first degrees of inclination of the lever around the axis X.

The elastic member 70 is also inserted, in said transverse direction T, between a first 66 of the movable pins 66, 68 and a second 68 of said movable pins 66, 68. In other words, the movable pins 66, 68 flank the elastic member 70 in the transverse direction T.

When the cradle 30 is in its neutral position, as shown in FIG. 3, a first distance d₁ between the first movable pin 66 and the first branch 72 of the elastic member 70 is substantially equal to a second distance d₂ between the second movable pin 68 and the second branch 74 of the elastic member 70. Each of said distances d₁, d₂ consists of the minimum distance between the outer surface of the movable pin, respectively 66, 68, and the outer surface of the branch, respectively 72, 74, of the elastic member 70.

In particular, these first and second distances d₁, d₂ are nil, i.e. the first branch 72 of the elastic member 70 is flush with the first movable in 66 and the second branch 74 of the elastic member 70 is flush with the second movable pin 68 when the cradle 30 is in its neutral position.

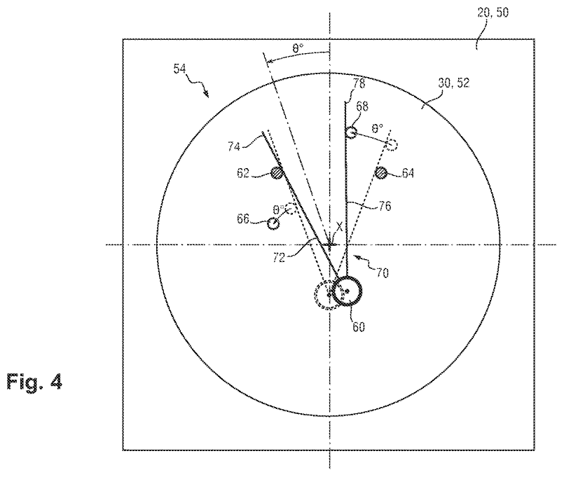

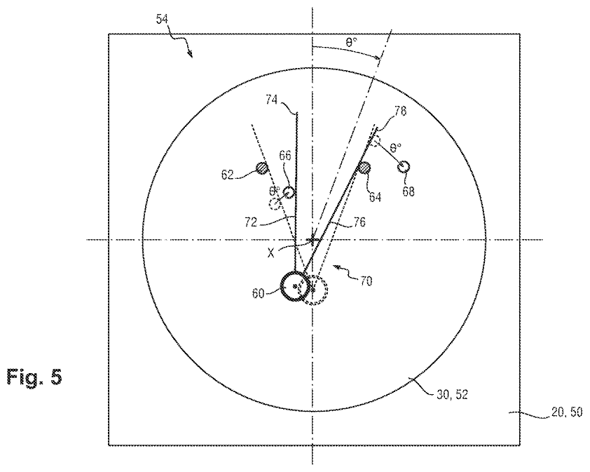

The elastic member 70 is thus inserted in the transverse direction T, between the first stationary pin 62 and the second movable pin 68 on the one hand, and between the second stationary pin 64 and the first movable pin 66 on the other hand. Thus, when the cradle 30 is pivoted in a first direction around the axis X, as shown in FIG. 4, the movement of the second movable pin 68 toward the first stationary pin 62 generated by this pivoting causes a convergence of the first and second free ends 74, 78 of the branches 72, 76 of the elastic member 70, a convergence which the elastic member 70 opposes, hence exerting a counter-force on the cradle 30, and thereby on the lever 22. Likewise, when the cradle 30 is pivoted in a second direction opposite to the first direction around the axis X, as shown in FIG. 5, the movement of the first movable pin 66 toward the second stationary pin 64 generated by this pivoting causes a convergence of the first and second free ends 74, 78 of the branches 72, 76 of the elastic member 70, a convergence which the elastic member 70 opposes, hence exerting a counter-force on the cradle 30, and thereby on the lever 22.

Inasmuch as the elastic member 70 is preloaded against the stationary pins 62, 64, the counter-force exerted by the return device 54 is perceptible beginning with the first degrees of inclination of the lever around the axis X.

Moreover, because each of the movable pins 66, 68 is at a zero distance from a branch 72, 76 of the elastic member 70, the elastic member 70 is found to be compressed beginning with the first degrees of inclination of the cradle 30 around the axis X, so that the counter-force exerted by the return device 54 begins to increase beginning with the first degrees of inclination of the cradle 30 around the axis X.

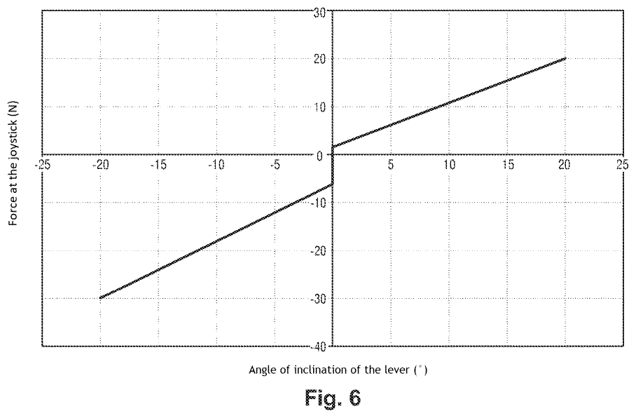

Finally, because the first movable pin 66 is at a smaller distance from the finger 60 than the second movable pin 68, the torque exerted by the elastic member 70 on the first movable pin 66 when the cradle 30 is pivoted by an angle θ around the axis X in the second direction is less than the torque exerted on the second movable pin 68 when the cradle 30 is pivoted by the same angle θ around the axis X in the first direction. This allows having an asymmetrical force law relative to the neutral position of the cradle 30, as can be seen in FIG. 6. It is thus possible to adjust the force law of the return device 54 so as to compensate the difference in strength of the pilot between pronation and supination.

It will be noted that this first variant of the return device 54 implies that the initial force necessary for the pivoting of the cradle 30 around the axis X (and therefore for the inclination of the lever about axis X) is different depending on the pivoting/inclination direction.

### First Variant of the Second Return Device 56

A first variant of the second return device 56 is presented in FIGS. 7 to 10.

With reference to FIG. 7, the second return device 56 comprises, according to this first variant, a primary finger 80 and a secondary finger 81 integral with the cradle 30, each finger 80, 81 protruding from a face of the cradle 30, parallel to the axis Y, toward the plate 49. Here each finger 80, 81 is eccentric, i.e. it is at a distance from the axis Y.

The fingers 80, 81 are preferably, as shown, substantially equidistant from the axis Y.

The second return device 56 also comprises four stationary pins 82, 83, 84, 85, each integral with the cradle 30 and protruding from a face of the cradle 30, parallel to the axis Y, toward the plate 49, and four movable pins 86, 87, 88, 89, each integral with the plate 49 and protruding from a face of the plate 49, parallel to the axis Y, toward the cradle 30. The stationary pins 82, 83, 84, 85 comprise primary stationary pins 82, 83 and secondary stationary pins 84, 85. Likewise, the movable pins 86, 87, 88, 89 comprise primary movable pins 86, 87 and secondary movable pins 88, 89.

Here, the primary stationary pins 82, 83 are substantially equidistant from the axis Y and are substantially equidistant from the primary finger 80. Likewise, the secondary stationary pins 84, 85 are substantially equidistant from the axis Y and are substantially equidistant from the secondary finger 81. In particular, the stationary pins 82, 83, 84, 85 are all substantially equidistant from the axis Y.

Moreover, here the primary movable pins 86, 87 are substantially equidistant from the axis Y and are substantially equidistant from the primary finger 80 when the lever 22 is in the neutral position. Likewise, the secondary movable pins 88, 89 are substantially equidistant from the axis Y and are substantially equidistant from the secondary finger 81 when the lever 22 is in the neutral position. In particular, the movable pins 86, 87, 88, 89 are all substantially equidistant from the axis Y.

In the example shown, the primary pins 82, 83, 86, 87 are on one side of the axis Y, the primary finger 80 being on the other side. In other words, there exists a plane containing the axis Y dividing the space into two halves, the primary pins 82, 83, 86, 87 being contained in a first of these halves and the primary finger 80 being contained in the second half. Likewise, the secondary pins 84, 85, 88, 89 are on one side of the axis Y, the secondary finger 81 being on the other side. In other words, there exists a plane containing the axis Y dividing the space into two halves, the secondary pins 84, 85, 88, 89 being contained in a first of these halves and the secondary finger 81 being contained in the second half. This arrangement allows good compactness of the return device 56.

In the example shown, the primary pins 82, 83, 86, 87 are on the same side of the axis Y as the secondary finger 81, and the secondary pins 84, 85, 88, 89 are on the same side of the axis Y as the primary finger 80.

The second return device 56 also comprises a plurality of elastic members 90, 91 each of them V-shaped. Here these elastic members 90, 91 are two in number and comprise a primary elastic member 90 and a secondary elastic member 91. As a variant (not shown), the number of elastic members 90, 91 is equal to three or more.

The primary elastic member 90 comprises a first branch 92 extending in a first direction L11 orthogonal to the axis Y from the primary finger 80 until a first free end 93 and a second branch 94 extending in a second direction L12 orthogonal to the axis Y from the primary finger 80 to a second free end 95. These directions L11, L12 form an angle (not labeled). This angle is divided into two equal halves by a bisector K1. Advantageously, this bisector K1, as shown, intersects with the axis Y when the lever 22 is in its neutral position.

The secondary elastic member 91 comprises a first rectilinear branch 96 extending in a first direction L21 orthogonal to the axis Y from the secondary finger 81 until a first free end 97 and a second rectilinear branch 98 extending in a second direction L22 orthogonal to the axis Y from the secondary finger 81 until a second free end 99. These directions L21, L22 form an angle (not labeled). This angle is divided into two equal halves by a bisector K2. Advantageously, this bisector K2, as shown intersects the axis Y when the lever 22 is in its neutral position. Preferably, the bisector K2 is, as shown, conflated with the bisector K1.

Each of said elastic members 90, 91 is able to oppose a convergence of its first and second free ends 93, 95, 97, 99.

Each elastic member 90, 91 consists for example, as shown, of a torsion spring wound around the primary 80 or secondary 81 finger. As a variant (not shown), at least one of these elastic members 90, 91 consists of a couple of leaf springs made integral with the finger 80, respectively 81, at one of their ends, each leaf spring constituting one of the branches 92, 94, respectively 96, 98, of the elastic member 90, respectively 91.

The elastic member 90 is inserted, in a transverse direction Q1 orthogonal to the axis Y and to the bisector K1 of the angle between the first and second directions L11, L12, between a first 82 of the primary stationary pins 82, 83 and a second 83 of said primary stationary pins 82, 83. In other words, the primary stationary pins 82, 83 flank the primary elastic member 90 in the transverse direction Q1.

Likewise, the secondary elastic member 91 is inserted in a transverse direction Q2 orthogonal to the axis Y and to the bisector K2 of the angle between the first and second directions L21, L22, between a first 84 of the secondary stationary pins 84, 85 and a second 85 of said secondary stationary pins 84, 85. In other words, the secondary stationary pins 84, 85 flank the secondary elastic member 91 in the transverse direction Q2.

In particular, the first branch 92 of the primary elastic member 90 is in contact with the first primary stationary pin 82 and the second branch 94 of the primary elastic member 90 is in contact with the second primary stationary pin 83 when the lever 22 is in its neutral position. Likewise, the first branch 96 of the secondary elastic member 91 is in contact with the first secondary stationary pin 84 and the second branch 98 of the secondary elastic member 91 is in contact with the second secondary stationary pin 85 when the lever 22 is in its neutral position. Preferably, the contacts of the branches 92, 94 of the primary elastic member 90 with the primary stationary pins 82, 83 and/or the contacts of the branches 96, 98 of the secondary elastic member 91 with the secondary stationary pins 84, 85 are supported contacts, i.e. the branches 92, 94 of the primary elastic member 90 are supported against the primary stationary pins 82, 83 and/or the branches 96, 98 of the secondary elastic member 91 are supported against the secondary stationary pins 84, 85 when the lever 22 is in its neutral position. To this end, the primary elastic member 90 is preloaded between said primary stationary pins 82, 83 and/or the secondary elastic member 91 is preloaded against said secondary stationary pins 84, 85.

The primary elastic member 90 is also inserted, in said transverse direction Q1, between a first 86 of the primary movable pins 86, 87 and a second 87 of said primary movable pins 86, 87. In other words, the primary movable pins 86, 87 flank the primary elastic member 90 in the transverse direction Q1.

When the joystick 22 is in its neutral position, as shown in FIG. 7, the first primary movable pin 86 is at a first primary distance a₁ from the first branch 92 of the elastic member 90 and the second primary movable pin 87 is at a second primary distance a₂ from the second branch 94 of the elastic member 90. Each of these distances a₁, a₂ consist of the minimum distance between the outer surface of the primary movable pin, respectively 86, 87, and the outer surface of the branch, respectively 92, 94, of the elastic member 90. Advantageously, said first primary distance a₁ and second primary distance a₂ are substantially equal to one another. As a variant (not shown) the first and second primary distances a₁, a₂ are different from one another.

Preferably, the first and second primary distances a₁, a₂ are, as shown, nil, i.e. the first branch 92 of the elastic member 90 is flush with the first primary movable pin 86 and the second branch 93 of the elastic member 90 is flush with the second primary movable pin 87 when the lever 22 is in its neutral position.

Likewise, the secondary elastic member 91 is also inserted, in said transverse direction Q2, between a first 88 of the secondary movable pins 88, 89 and a second 89 of said secondary movable pins 88, 89. In other words, the secondary movable pins 88, 89 flank the secondary elastic member 91 in the transverse direction Q2.

When the joystick 22 is in its neutral position, as illustrated in FIG. 7, the first secondary movable pin 88 is at a first secondary distance b₁ from the first branch 96 of the elastic member 91 and the second secondary movable pin 89 is at a second secondary distance b₂ from the second branch 98 of the elastic member 91. Each of these distances b₁, b₂ consists of the minimum distance between the outer surface of the secondary movable pin, respectively 88, 89, and the outer surface of the branch, respectively 96, 98, of the elastic member 91. Advantageously, said first secondary distance b₁ and second secondary distance b₂ are substantially equal to one another. As a variant (not shown), the first and second secondary distances b₁, b₂ are different from one another.

Advantageously, the first and second secondary distances b₁, b₂ are, as shown, strictly greater than the first and second primary distances a₁, a₂.

The primary elastic member 90 is thus inserted, in the transverse direction Q1, between the first primary stationary pin 82 and the second primary movable pin 87 on the one hand, and between the second primary stationary pin 83 and the first primary movable pin 86 on the other hand. Likewise, the secondary elastic member 91 is thus inserted, in the transverse direction Q2, between the first secondary stationary pin 84 and the second secondary movable pin 89 on the one hand, and between the second secondary stationary pin 85 and the first secondary movable pin 88 on the other hand.

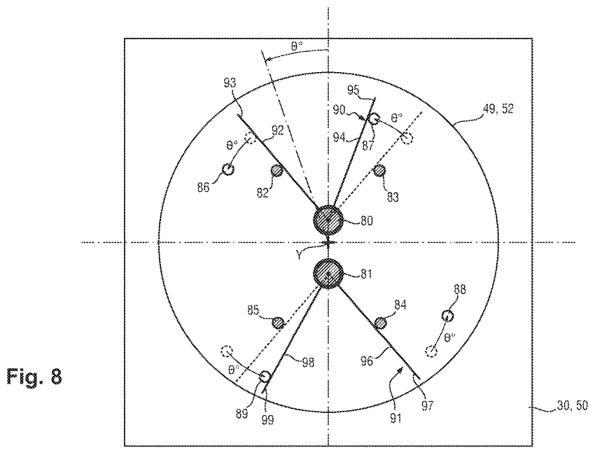

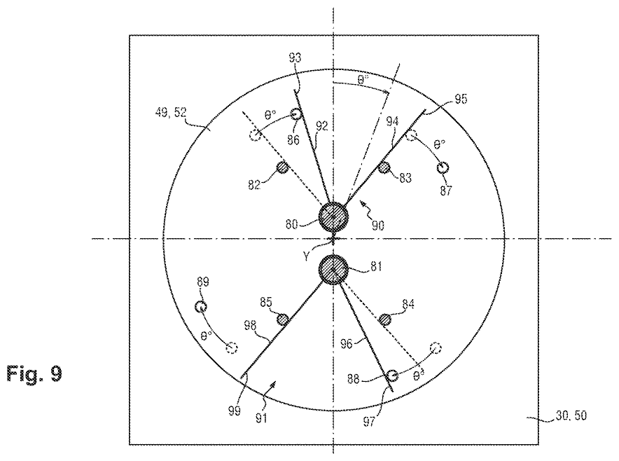

Thus, when the lever 22 is pivoted in a first direction around the axis Y, as shown in FIG. 8, the movement of the second primary movable pin 87 toward the first primary stationary pin 82 and the movement of the second secondary movable pin 89 toward the first secondary stationary pin 84 generated by this pivoting cause a convergence of the first and second free ends 93, 95 of the branches 92, 94 of the primary elastic member 90 and a convergence of the first and second free ends 97, 99 of the branches 96, 98 of the secondary elastic member 91, convergences which are opposed by the elastic member 90, 91, hence exerting a counter-force on the lever 22. Likewise, when the lever 22 is pivoted in a second direction, opposite to the first direction, around the axis Y, as shown in FIG. 9, the movement of the first primary movable pin 86 toward the second primary stationary pin 83 and the movement of the first secondary movable pin 88 toward the second secondary stationary pin 85 generated by this pivoting cause a convergence of the first and second free ends 93, 95 of the branches 92, 94 of the primary elastic member 90 and a convergence of the first and second free ends 97, 99 of the branches 96, 98 of the secondary elastic member 91, convergences which are opposed by the elastic member 90, 91, hence exerting counter-force on the lever 22.

Due to the arrangement of the primary 82, 83, 86, 87 and secondary 84, 85, 88, 89 pins relative respectively to the primary finger 80 and to the secondary finger 81, the counter-force of the elastic members 90, 91 is symmetrical relative to the neutral position, i.e. at equal inclination angle, the counter-force exerted is the same whether this inclination is observed in the first direction or in the second direction.

Moreover, the primary elastic member 90 being preloaded between the primary stationary pins 82, 83 and/or the secondary elastic member 91 being preloaded between the secondary stationary pins 84, 85, the return device 56 exerts a significant counter-force beginning with the first degrees of inclination of the lever 22 around the axis Y.

In addition, the first branch 92 of the elastic member 90 being flush with the first primary movable pin 86 and the second branch 93 of the elastic member 90 being flush with the second primary movable pin 87 when the lever 22 is in its neutral position, the elastic member 90 is found to be compressed beginning with the first degrees of inclination of the lever 22 around the axis Y, so that the counter-force exerted by the return device 56 beings to increase beginning with the first degrees of inclination of the lever 22 around the axis Y.

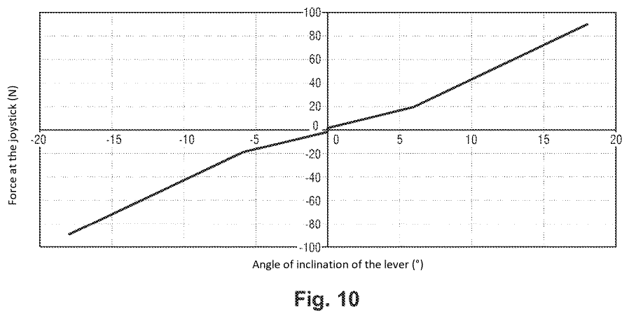

Finally, because the first and second secondary distances b₁, b₂ are strictly greater than the first and second primary distances a₁, a₂, the secondary movable pins 88, 89 come into contact with the branches 96, 98 of the secondary elastic member 91 during the pivoting of the lever 22 around the axis Y, after the primary movable pins 86, 87 are entered into contact with the branches 92, 94 of the primary elastic member 90. The resistance of the secondary elastic member 91 to the pivoting of the lever 22 thus begins only to be exerted once the lever 22 has reached a predetermined inclination. Thus, the counter-force exerted by the return device 56 is reinforced starting with the predetermined inclination. This allows having a force law the slope of which varies with the inclination, as shown in FIG. 10.

It will be noted that it is also possible, with this variant, to have a force law of the return device 56 having several slope changes. That is in fact the case when the number of elastic members is equal to three or more. It is then required that the return device comprise as many fingers, pairs of stationary pins and pairs of movable pins as elastic member, each elastic member being associated with a pair of movable pins flanking the elastic member and co-distant from the branches of the elastic member, each pair of movable pins being at a distance from the branches of the associated elastic member that is different from the distance of each other pair of movable pins to the branches of the associated elastic member.

### Second Variant of the First Return Device 54

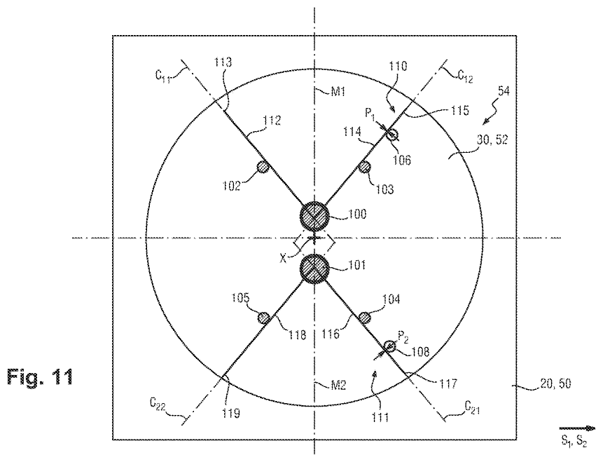

A second variant of the first return device 54 is presented in FIGS. 11 to 14.

With reference to FIG. 11, the first return device 54 comprises, according to this second variant, a primary finger 100 and a secondary finger 101 integral with the frame, each finger 100, 101 protruding from a face of the frame 20, parallel to the axis X, toward the cradle 30. Here each finger 100, 101 is eccentric, i.e. it is at a distance from the axis X.

The first return device 54 also comprises four stationary pins 102, 103, 104, 105, each integral with the cradle 30 and protruding from a face of the frame 20, parallel to the axis X, toward the cradle 30, and two movable pins 106, 108, each integral with the cradle 30 and protruding from a face of the cradle 30, parallel to the axis X, toward the frame 20. The stationary pins 102, 103, 104, 105 comprise primary stationary pins 102, 103 and secondary stationary pins 104, 105. Likewise, the movable pins 106, 108 comprise a primary movable pin 106 and a secondary movable pin 108.

Here, the primary stationary pins 102, 103 are substantially equidistant from the axis X and are substantially equidistant from the primary finger 100. Likewise, the secondary stationary pins 104, 105 are substantially equidistant from the axis X and are substantially equidistant from the secondary finger 101. In particular, the stationary pins 102, 103, 104, 105 are all substantially equidistant from the axis X.

Moreover, here the primary movable pins 106, 107 are substantially equidistant from the axis X and are substantially equidistant from the primary finger 100 when the cradle 30 is in the neutral position. Likewise, the secondary movable pins 108, 109 are substantially equidistant from the axis X and are substantially equidistant from the secondary finger 101 when the cradle 30 is in the neutral position. In particular, the movable pins 106, 107, 108, 109 are all substantially equidistant from the axis X.

In the example shown, the primary pins 102, 103, 106 are on the same side of the axis X as the primary finger 100. In other words, there exists a plane containing the axis X dividing the space into two halves, the primary pins 102, 103, 106 being contained in the same of these halves as the primary finger 100. Likewise, the secondary pins 104, 105, 108 are on the same side of the axis X as the secondary finger 101. In other words, there exists a plane containing the axis X dividing the space into two halves, the secondary pins 104, 105, 108 being contained in the same of these halves as the secondary finger 101.

The first return device 54 also comprises a primary elastic member 110 and a secondary elastic member 111, each of them V-shaped.

The primary elastic member 110 comprises a first branch 112 extending in a first direction C11, orthogonal to the axis X from the primary finger 100 until a first free end 113, and a second branch 114 extending in a second direction C12 orthogonal to the axis X from the primary finger 100 until a second free end 115. These directions C11, C12 form an angle (not labeled). This angle is divided into two equal halves by a bisector M1. Advantageously, this bisector M1, as shown, intersects the axis X when the cradle 30 is in its neutral position.

The secondary elastic member 111 comprises a first rectilinear branch 116 extending in a first direction C21 orthogonal to the axis X from the secondary finger 101 until a first free end 117, and a second rectilinear branch 118 extending in a second direction C22 orthogonal to the axis X from the secondary finger 101 until a second free end 119. These directions C21, C22 form an angle (not labeled). This angle is divided into two equal halves by a bisector M2. Advantageously, this bisector M2, as shown, intersects the axis X when the cradle 30 is in its neutral position. Preferably, the bisector M2 is, as shown, conflated with the bisector M1.

### Each of Said Elastic Members 110, 111 Is Able to Oppose a Convergence of its First and second free ends 113, 115, 117, 119.

Each elastic member 110, 111 consists for example of a torsion spring wound around the primary 100 or secondary 101 finger. As a variant (not shown), at least one of these elastic members 110, 111 consists of a couple of leaf springs made integral with the finger 100, respectively 101, at one of their ends, each leaf spring constituting one of the branches 112, 114, respectively 116, 118, of the elastic member 110, respectively 111.

The primary elastic member 110 is inserted, in a transverse direction S1 orthogonal to the axis X and to the bisector M1 of the angle between the first and second directions C11, C12, between a first 102 of the primary stationary pins 102, 103 and a second 103 of said primary stationary pins 102, 103. In other words, the primary stationary pins 102, 103 flank the primary elastic member 110 in the transverse direction S1.

Likewise, the secondary elastic member 111 is inserted in a transverse direction S2 orthogonal to the axis X and to the bisector M2 of the angle between the first and second directions C21, C22, between a first 104 of the secondary stationary pins 104, 105 and a second 105 of said secondary stationary pins 104, 105. In other words, the secondary stationary pins 104, 105 flank the secondary elastic member 111 in the transverse direction S2.

In particular, the first branch 112 of the primary elastic member 110 is in contact with the first primary stationary pin 102 and the second branch 114 of the primary elastic member 110 is in contact with the second primary stationary pin 103 when the cradle 30 is in its neutral position. Likewise, the first branch 116 of the secondary elastic member 111 is in contact with the first secondary stationary pin 104 and the second branch 118 of the secondary elastic member 111 is in contact with the second secondary stationary pin 105 when the cradle 30 is in its neutral position. Preferably the contacts of the branches 112, 114 of the primary elastic member 110 with the primary stationary pins 102, 103 and the contacts of the branches 116, 118 of the secondary elastic element 111 with the secondary stationary pins 104, 105 are supported contacts, i.e. the branches 112, 114 of the primary elastic members 110 are supported against the primary stationary pins 102, 103 and the branches 116, 118 of the secondary elastic member 111 are supported against the secondary stationary pins 104, 105 when the cradle 30 is in its neutral position. To this end, the primary elastic member 110 is preloaded between said primary stationary pins 102, 103 and the secondary elastic member 111 is preloaded between said secondary stationary pins 104, 105.

The primary movable pin 106 is located on a first side of the primary elastic member 110 in the trigonometric sense, in proximity to the second branch 114 of the elastic member 110. It is at a primary distance p₁ from said second branch 114 when the cradle 30 is in its neutral position, this distance p₁ consisting of the minimum distance between the outer surface of the primary movable pin 106 and the outer surface of the second branch 114.

The secondary movable pin 108 is located on a second side, opposite to the first side, of the secondary elastic member 111 in the trigonometric sense, in proximity to the first branch 116 of the elastic member 111. It is at a secondary distance p₂ from said first branch 116 when the cradle 30 is in its neutral position, this distance p₂ consisting of the minimum distance between the outer surface of the secondary movable pin 108 and the outer surface of said first branch 116.

In particular, the primary and secondary distances p₁, p₂ are preferably, as shown, substantially equal to one another. Advantageously, these primary and secondary distances p₁, p₂ are, as shown, nil, i.e. the second branch 114 of the primary elastic member 110 is flush with the primary movable pin 106 and the first branch 116 of the secondary elastic member 111 is flush with the secondary movable pin 108 when the cradle 30 is in its neutral position.

The primary elastic member 110 is thus inserted, in said transverse direction S1, between the first primary stationary pin 102 and the primary movable pin 106. Likewise, the secondary elastic member 111 is thus inserted, in said transverse direction S2, between the second secondary stationary pin 105 and the secondary movable pin 108.

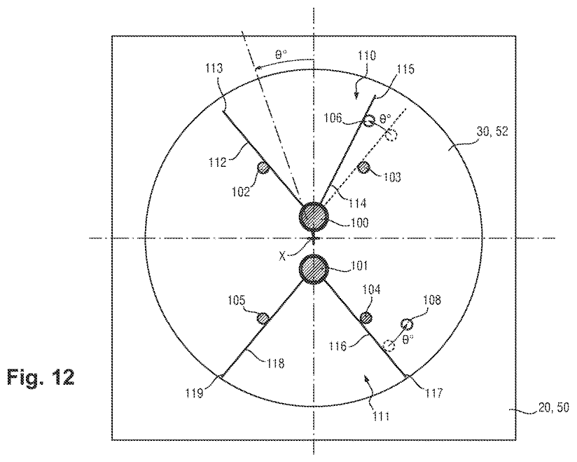

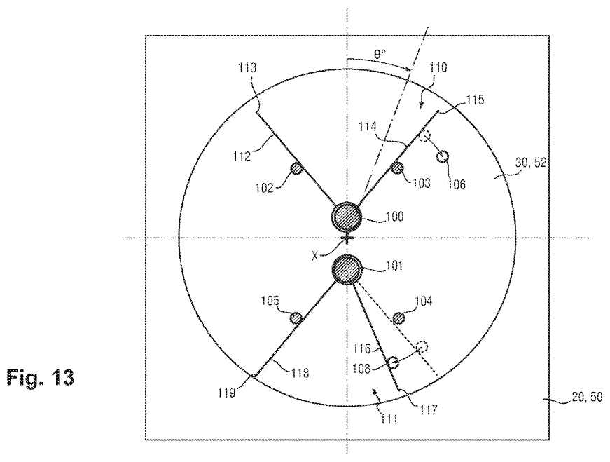

Thus, when the cradle 30 is pivoted in a first direction around the axis X, as shown in FIG. 12, the movement of the primary movable pin 106 toward the first primary stationary pin 102 generated by this pivoting causes a convergence of the first and second free ends 113, 115 of the branches 112, 114 of the primary elastic member 110, a convergence which the elastic member 110 opposes, hence exerting a counter-force on the cradle 30. Likewise, when the cradle 30 is pivoted in a second direction opposite to the first direction around the axis X, as shown in FIG. 13, the movement of the secondary movable pin 108 toward the second secondary stationary pin 105 generated by this pivoting causes a convergence of the first and second free ends 117, 119 of the branches 116, 118 of the secondary elastic member 111, a convergence which the elastic member 111 opposes, hence exerting a counter-force on the cradle 30.

The second branch 114 of the primary elastic member 110 being flush with the primary movable pin 106 and the second branch 116 of the secondary elastic member 111 being flush with the secondary movable pin 108 when the cradle 30 is in its neutral position, this counter-force exerted by the return device 54 begins to increase, beginning with the first degrees of inclination of the cradle 30 around the axis X.

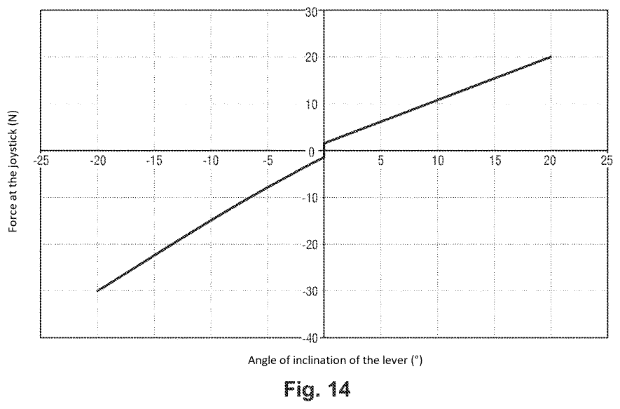

Advantageously, the primary elastic member 110 has a different stiffness than that of the secondary elastic member 111, which allows having a force law that is asymmetrical relative to the neutral position of the cradle 30, as can be seen in FIG. 14. It is thus possible to adjust the force law of the return device 54 so as to compensate the difference of strength of the pilot between pronation and supination.

Moreover, the primary elastic member 110 being preloaded between the primary stationary pins 102, 103 and the secondary elastic member 111 being preloaded between the secondary stationary pins 104, 105, the return device 54 exerts a significant counter-force beginning with the first degrees of inclination of the cradle 30, and therefore of the lever 22, around the axis X.

Advantageously, the same preload is applied to the primary and secondary elastic members 110, 111. As can be seen in FIG. 14, this allows, unlike the first variant of the return device 54, having an initial force necessary for the pivoting of the cradle 30 around the axis X (and therefore for the inclination of the lever 22 about the axis X) that is identical regardless of the pivoting/inclination direction.

### Second Variant of the Second Return Device 56

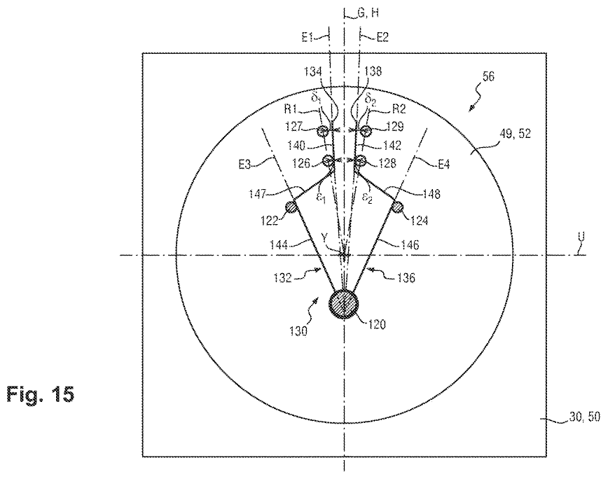

A second variant of the second return device 56 is shown in FIGS. 15 to 17.

With reference to FIG. 15, the second return device 56 comprises, according to this second variant, a finger 120 integral with the cradle 30, this finger 20 protruding from a face of the cradle 30, parallel to the axis Y, toward the plate 49. Here the finger 120 is eccentric, i.e. it is at a distance from the axis Y.

The second return device 56 also comprises two stationary pins 122, 124, each integral with the cradle 30 and protruding from a face of the cradle 30, parallel to the axis Y, toward the plate 49, and four movable pins 126, 127, 128, 129, each integral with the plate 49 and protruding from a face of the plate 49, parallel to the axis Y, toward the cradle 30.

Here, the stationary pins 122, 124 are substantially equidistant from the axis Y. Moreover, the stationary pins 122, 124 are substantially equidistant from the finger 120 when the lever 22 is in its neutral position.

The movable pins 126, 127, 128, 129 comprise first movable pins 126, 127 aligned in a first straight line R1 intersecting the axis Y and second movable pins 128, 129 aligned in a second straight line R2 also intersecting the axis Y. The first movable pins 126, 127 comprise as first proximal movable pin 126, relatively close to the axis Y, and a first distal movable pin 127, relatively distant from the axis Y. The second movable pins 128, 129 comprise a second proximal movable pin 128, relatively close to the axis Y, and a second distal movable pin 129, relatively distant from the axis Y.

Here, the proximal movable pins 126, 128 are substantially equidistant from the axis Y and are substantially equidistant from the finger 120 when the lever 22 is in its neutral position. In addition, the distal movable pins 127, 129 are substantially equidistant from the axis Y and are substantially equidistant from the finger 120 when the lever 22 is in its neutral position.

Moreover, here each of the movable pins 126, 127, 128, 129 is at a distance from the axis Y that is greater than the distance of each of the stationary pins 122, 124 from the axis Y. In addition, when the lever 22 is in its neutral position, each of the movable pins 126, 127, 128, 129 is at a distance from the finger 120 that is greater than the distance of each of the stationary pins 122, 124 from the finger 120.

In the example shown, the pins 122, 124, 126, 127, 128, 129 are on one side of the axis Y, the finger 120 being on the other side. In other words, there exists a plane containing the axis Y dividing the space into two halves, the pins 122, 124, 126, 127, 128, 129 being contained in a first of these halves and the finger 120 being contained in the second half. This arrangement allows good compactness of the return device 56.

The second return device 56 also comprises a single V-shaped elastic member 130 including a first branch 132 extending from the finger 120 until a first free end 134 and a second rectilinear branch 136 extending from the finger 120 until a second free end 138.

Each of the branches 132, 136 comprises a primary rectilinear portion, respectively 140, 142, configured to come into contact with the movable pins 126, 127, 128, 129. In the example shown, these primary rectilinear portions 140, 142 constituting distal portions of the branches 132, 136, relatively distant from the finger 120, and comprise in particular the free ends 134, 138 of the branches 132, 136.

The primary rectilinear portion 140 of the first branch 130 extends in a first direction E1 orthogonal to the axis Y. This first direction E1 intersects the finger 120 and in particular passes through the center of the finger 120. Thus, the first direction E1 does not intersect the axis Y when the lever 22 is in its neutral position.

The primary rectilinear portion 142 of the second branch 132 extends in a second direction E2 orthogonal to the axis Y. This second direction E2 intersects the finger 120 and in particular passes through the center of the finger 120. Thus, the second direction E2 does not intersect the axis Y when the lever 22 is in its neutral position.

These directions E1, E2 form a first angle (not labeled). This angle is divided into two equal halves by a bisector G. Advantageously, this bisector G, as shown, intersects the axis Y when the lever 22 is in its neutral position.

Each of the branches 130, 132 also comprises a secondary rectilinear portion, respectively 144, 146, configured to come into contact with the stationary pins 122, 124. In the example shown these secondary rectilinear portions 144, 146 consist of the proximal portions of the branches 132, 136, relatively close to the finger 120, and extending in particular from the finger 120.

Here, each of the branches 132, 136 is bent so that its secondary rectilinear portion, respectively 144, 146, is not aligned with its primary rectilinear portion, respectively 140, 142. The proximal portion 144, 146 of each branch 132, 134 is connected to the distal portion, respectively 140, 142, of said branch 132, 134 by a connecting portion, respectively 147, 148.

The secondary rectilinear portion 144 of the first branch 132 extends in a third direction E3 orthogonal to the axis Y. This third direction E3 intersects the finger 120 and in particular passes through the center of the finger 120. Thus, the third direction E3 does not intersect the axis Y when the lever 22 is in its neutral position.

The secondary rectilinear portion 146 of the second branch 136 extends in a fourth direction E4 orthogonal to the axis Y. This fourth direction E4 intersects the finger 120 and in particular passes through the center of the finger 120. Thus the fourth direction E4 does not intersect the axis Y when the lever 22 is in its neutral position.

These directions E3, E4 form a second angle (not labeled) that is greater than the first angle. This angle is divided into two equal halves by a bisector H. Advantageously, this bisector H, as shown, intersects the axis Y when the lever 22 is in its neutral position. The bisector H is typically conflated with the bisector G.

The elastic member 130 is able to oppose a convergence of the first and second free ends 134, 138.

The elastic member 130 consists for example, as shown, of a torsion spring wound around the finger 120. As a variant (not shown), the elastic member consists of a pair of leaf springs made integral with the finger 120 at one of their ends, each leaf spring constituting one of the branches 132, 136 of the elastic member 130.

The elastic member 130 is inserted, in a transverse direction U orthogonal to the axis Y and to the bisector G of the angle between the first and second directions E1, E2, between a first 122 of the stationary pins 122, 124 and a second 124 of said stationary pins 122, 124. In other words, the stationary pins 122, 124 flank the elastic member 130 in the transverse direction U.

In particular, the proximal portion 144 of the first branch 132 of the elastic member 130 is in contact with the first stationary pin 122 and the proximal portion 136 of the second branch 134 of the elastic member 130 is in contact with the second stationary pin 124 when the lever 22 is in its neutral position. Preferably, each of these contacts is supported, i.e. the proximal portion 144 of the first branch 132 of the elastic member 130 is supported against the first stationary pin 122 and the proximal portion 136 of the second branch 134 of the elastic member 130 is supported against the second stationary pin 124 when the lever 22 is in its neutral position. To this end, the elastic member 130 is preloaded between said stationary pins 122, 124. Thus, the return device 56 exerts a significant counter-force beginning with the first degrees of inclination of the lever 22 around the axis Y.

The elastic member 130 is also inserted, in said transverse direction U, between the first movable pins 126, 127, on the one hand, and the second movable pins 128, 129, on the other hand. In other words, the movable pins 126, 127, 128, 129 flank the elastic member 130 in the transverse direction U.

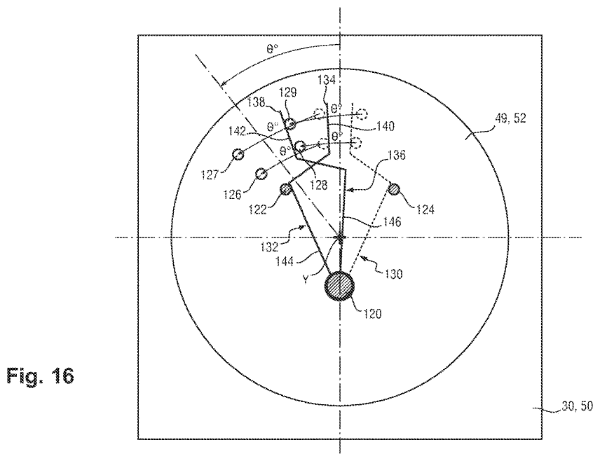

The elastic member 130 is thus inserted, in the transverse direction U, between the first stationary pin 122 and the second movable pins 128, 129, on the one hand, and between the second stationary pin 124 and the first movable pins 126, 127, on the other hand. Thus, when the lever 22 is pivoted in a first direction around the axis Y, as shown in FIG. 16, the movement of the second movable pins 128, 129 toward the first stationary pin 122 generated by this pivoting causes a convergence of the first and second free ends 134, 138 of the branches 132, 136 of the elastic member 130, a convergence which the elastic member 130 opposes, hence exerting a counter-force on the lever 22. Likewise, when the lever 22 is pivoted in a second direction opposite to the first direction around the axis Y, the movement of the first movable pins 126, 127 toward the second stationary pin 124 generated by this pivoting causes a convergence of the first and second free ends 134, 138 of the branches 132, 136 of the elastic member 130, a convergence which the elastic member 130 opposes, hence exerting a counter-force on the lever 22.

When the lever 22 is in its neutral position, as shown in FIG. 15, the first proximal movable pin 126 is at a first proximal distance ε₁ from the first branch 132 of the elastic member 130, the first distal movable pin 127 is at a first distal distance δ₁ from the first branch 132 of the elastic member 130, the second proximal movable pin 128 is at a second proximal distance ε₂ from the second branch 134 of the elastic member 130 and the second distal movable pin 129 is at a second distal distance δ₂ from the second branch 134 of the elastic member 130. Each of said distances ε, ε₂, δ₁, δ₂ consists of the minimum distance between the outer surface of the movable pin, respectively 126, 127, 128, 129, and the outer surface of the branch, respectively 132, 134, of the elastic member 130.

Preferably, the first proximal distance ε₁ is, as shown, substantially equal to the second proximal distance ε₂. Likewise, the first distal distance δ₁ is preferably, as shown, substantially equal to the second distal distance δ₂.

In particular, the first and second proximal distances ε₁, ε₂ are nil, i.e. the first branch 132 of the elastic member 130 is flush with the first movable pin 126 and the second branch 134 of the elastic member 130 is flush with the movable pin 128 when the lever 22 is in its neutral position. Thus, the counter-force exerted by the return device 56 begins to increase beginning with the first degrees of inclination of the lever 22 around the axis Y.

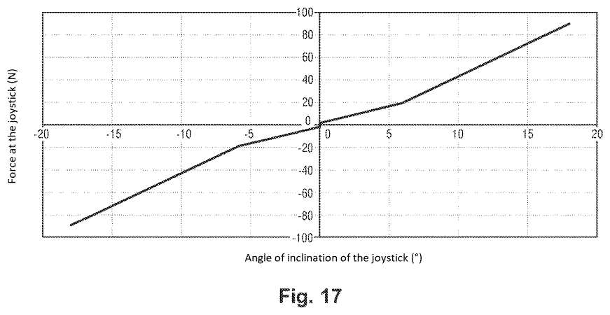

Advantageously, the first distal distance δ₁ is, as shown, strictly greater than the first proximal distance ε₁. Likewise, the second distal distance δ₂ is, as shown, strictly greater than the second proximal distance ε₂. Thus, when the lever 22 begins to pivot around the axis Y, only the first or second proximal pin 126, 128 (depending on the pivoting direction) presses on the elastic member 130. The counter-force generated by the return device 56 therefor depends only on the torque exerted by the elastic member 130 on the first or second proximal pin 126, 128. It is only when the pivoting of the lever 22 is such that the first or second direction E1, E2 begins to intersect the axis Y that the first, respectively the second distal pin 127, 129 comes into contact with the elastic member 130. Beginning with this inclination, the counter-force generated by the return device 56 thus depends on the torque exerted by the elastic member 130 on the first and second distal pin 127, 129. The latter being farther from the finger 120 than the corresponding proximal pin 126, 128, the torque exerted by the elastic member 130 is greater, so that the counter-force produced by the return device 56 is increased. This allows having a force law the slope of which varies with inclination, as shown in FIG. 17.

### Third Variant of the First Return Device 54

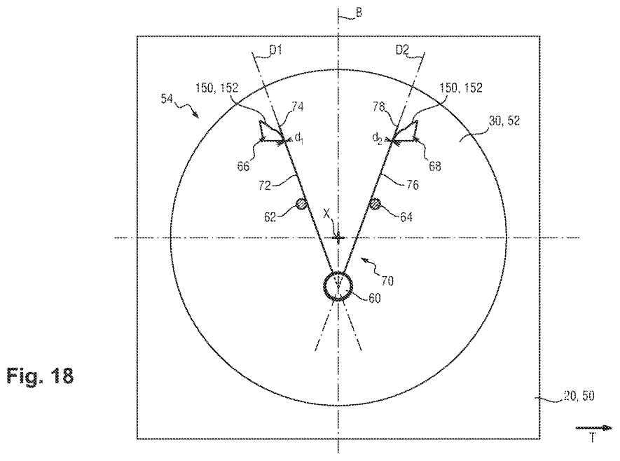

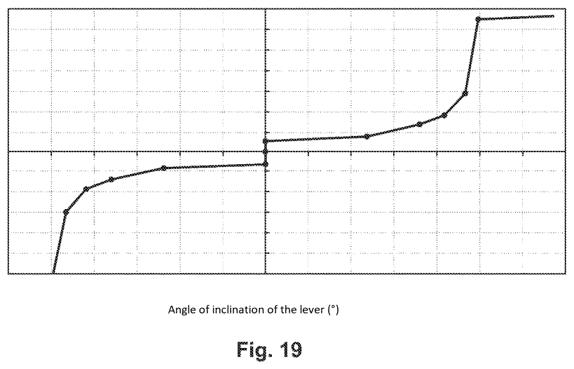

A third variant of the first return device 54 is presented in FIGS. 18 and 19. This third variant is very close to the first variant, the same reference symbols are used as for the description of the latter for elements common to the two variants.

With reference to FIG. 18, this third variant differs from the first variant only by the following features.

First of all, the movable pins 66, 68 are not at different distances from the axis X or from the finger 60: on the contrary, the movable pins 66, 68 are substantially equidistant from the axis X and substantially equidistant from the finger 60 when the cradle 30 is in its neutral position. The distances r₁, r₂ are therefore substantially equal to each other.

Then each movable pin 66, 68 has a support surface 150 against the first, respectively against the second branch 72, 76 of the elastic member 70 which is particular: this support surface 150 consists in fact of a cam surface 152. This allows varying the distance between the support point of the movable pin 66, 68 against the branch, respectively 72, 76, depending on the angle of inclination of the cradle 30 around the axis X, and thus varying the torque exerted by the elastic member 70 and therefore the counter-force produced by the return device 70. This allows obtaining a very complex force law of the return device 54, of the “smooth law” type, as can be seen in FIG. 19. In addition, this makes the return device easily configurable, in that, for obtaining a specific force law, it is sufficient to modify the profile of the cam surface 152.

Thus, due to the exemplary embodiments described above, it is possible to produce a complex force law for a control device of the joystick type by means of a simple passive force feedback system, this force feedback system being compact, economical, easy to implement and easy to configure.

Although the features of the invention have been described here in different variants, the features of these different variants can be freely combined with one another. For example, the features of the first and second variants of the second return device 56 are freely applicable to the first return device 54, which has the features of these variants, particularly when the axis X constitutes the pitch axis. Likewise, the features of the first, second and third variants of the first return device 54 are freely applicable to the second return device 56, which has the features of these variants particularly when the axis Y constitutes the roll axis. Moreover, the fact of having a movable pin support surface consisting of a cam surface, as described in the third variant of the first return device 54, is freely applicable to all the variants of the return device 54, 56 described here.

1. A control device including a frame a control lever and a mechanical seal guiding the control lever in rotation relative to the frame about two pivot connections with orthogonal axes, the mechanical seal comprising, for each of said pivot connections, a part that is stationary relative to the axis of the pivot connection and a part that is jointly movable with the control lever around the axis, of the pivot connection relative to the stationary part the mechanical seal also comprising, for at least one of the pivot connections a device for returning the movable part into a predetermined position, called the neutral position, relative to the stationary part
wherein said return device comprises at least one elastic member including a first branch extending in a first direction orthogonal to the axis of the pivot connection from a finger integral with one of the movable and stationary parts until a first free end, and a second branch extending in a second direction orthogonal to the axis of the pivot connection from said finger until a second free end the or each elastic member being able to oppose a convergence of the first free end with the second free end, the elastic member being inserted, in a transverse direction orthogonal to the bisector of the angle between the first direction and the second direction between a stationary pin integral with the stationary part and a movable pin integral with the movable part,
and wherein the or each movable pin has a surface supported against the first or the second branch of the elastic member, said support surface being constituted by a cam surface

2. The control device according to claim 1, wherein the elastic member is inserted, in the transverse direction, between a first stationary pin integral with the stationary part and a second stationary pin integral with the stationary part.

3. The control device according to claim 2, wherein the first branch is supported against the first stationary pin and the second branch is supported against the second stationary pin when the movable part is in its neutral position, the elastic member being preloaded between said first stationary pin and said second stationary pin.

4. The control device according to claim 1, wherein the elastic member is inserted, in the transverse direction between a first movable pin integral with the movable part and a second movable pin integral with the movable part.

5. The control device according to claim 4, wherein, when the movable part is in its neutral position, a first distance between the first movable pin and the first branch is substantially equal to a second distance between the second movable pin and the second branch.

6. The control device according to claim wherein a first distance between the first movable pin and the finger is strictly less than or equal to a second distance between the second movable pin and the finger.

7. The control device according to claim 1, wherein the elastic member is inserted, in the transverse direction between, on the one hand, a plurality of movable pins integral with the movable part and, on the other hand, at least one stationary pin integral with the stationary part the movable pins being aligned along a straight line intersecting with the axis of the pivot connection and comprising a proximal movable pin, near the finger, and a distal movable pin, distant from the finger, the first branch comprising a rectilinear portion, able to be supported against said movable pins and extending in a direction not intersecting with the axis of the pivot connection when the movable part is in its neutral position, said portion being closer to the proximal movable pin that to the distal movable pin when the movable part is in its neutral position, the finger being integral with the stationary part.

8. The control device according to claim 1, wherein the return device comprises a plurality of elastic members.

9. The control device according to claim 8, wherein the elastic members comprise a primary elastic member inserted, in the transverse direction between a first primary movable pin integral with the movable part and a second primary movable pin integral with the movable part, and a secondary elastic member inserted, in the transverse direction between a first secondary movable pin integral with the movable part and a second secondary movable pin integral with the movable part, a first primary distance between the first primary movable pin and the first branch of the primary elastic member and/or a second primary distance between the second primary movable pin and the second branch of the primary elastic member being different from a first secondary distance between the first secondary movable pin and the first branch of the secondary elastic member and from a second secondary distance between the second secondary movable pin and the second branch of the secondary elastic member.
